(19) United States
(12) Patent Application Publication
(10) Pub. No.: US 2026/0341027 A1
(43) Pub. Date: Oct. 29, 2026

(54) Multi-Agent Artificial Intelligence System for Real-Time Occupancy Detection and Adaptive Building Automation

(71) Applicant: Akram Khalis, Kenilworth, NJ (US)

(72) Inventor: Akram Khalis, Kenilworth, NJ (US)

(21) Appl. No.: 19/532,279

(22) Filed: Feb. 6, 2026

Related U.S. Application Data
(60) Provisional application No. 63/755,242, filed on Feb. 6, 2025.
(60) Provisional application No. 63/755,246, filed on Feb. 6, 2025.
(60) Provisional application No. 63/755,417, filed on Feb. 7, 2025.
(60) Provisional application No. 63/756,004, filed on Feb. 7, 2025.

(51) Int. Cl. G06V 20/52; G05B 19/418

(52) U.S. Cl. CPC G06V 20/52; G05B 19/418

(57) ABSTRACT

The present invention discloses a multi-modal sensor-based artificial intelligence system for real-time occupancy detection and adaptive building resource management. The system collects real-time environmental, occupancy and behavioral data from distributed sensors and processes the data using machine learning-based sensor fusion and comfort inference models. Multiple AI agents negotiate allocation of building resources based on occupancy maps and inferred occupant comfort. The invention further discloses a closed-loop method that continuously adapts environmental control strategies based on feedback, thereby providing an intelligent, energy-efficient and occupant-centric building environment.

### FIELD OF THE INVENTION

This application claims benefit of co-pending U.S. provisional patent application Ser. No. 63/755,242 filed Feb. 6, 2025, U.S. provisional patent application Ser. No. 63/755,246 filed Feb. 6, 2025, U.S. provisional patent application Ser. No. 63/755,417 filed Feb. 7, 2025, and U.S. provisional patent application Ser. No. 63/756,004 filed Feb. 7, 2025. The aforementioned related patent applications are herein incorporated by reference in their entirety.

### FIELD OF THE INVENTION

The present invention relates generally to intelligent building management and automation systems. More particularly, the invention relates a multi-modal sensor based artificial intelligence (AI) system for real-time occupancy detection-based resource allocation through multiple AI agents and providing an adaptive environment to an occupant in a building

### BACKGROUND OF THE INVENTION

Modern buildings are becoming increasingly complex due to higher occupancy densities, diversified usage patterns and the widespread deployment of energy-intensive subsystems such as HVAC, lighting, ventilation and automated building controls. Conventional building management systems are largely based on static zoning, rule-based automation and limited sensing capabilities, which restrict their ability to adapt dynamically to real-time changes in occupancy and occupant behaviour.

With increasing emphasis on energy efficiency, sustainability and occupant well-being, there is a growing demand for intelligent building systems capable of accurately sensing occupancy, understanding environmental context and autonomously optimizing resource usage. However, many existing solutions operate in isolation, where sensing, decision-making and actuation are loosely integrated, leading to inefficiencies and reduced responsiveness.

Additionally, current systems often prioritize energy optimization without adequately accounting for occupant comfort, behavioral patterns or emotional well-being. This lack of human-centric intelligence results in environments that are either energy-inefficient or uncomfortable, requiring frequent manual intervention by occupants or facility managers.

A U.S. Publication US20120066168 assigned to Google LLC discloses an occupancy detection system that utilizes sensor data to infer presence within a building environment. Although, the system described recognizes the importance of occupancy detection for energy optimization, that primarily relies on limited sensing modalities. The system described above fails to provide a robust mechanism for accurately detecting stationary occupants or complex activity patterns.

Specifically, the US Publication US20120066168 fails to disclose a multi-modal sensor framework that integrates thermal, acoustic, motion and environmental sensors in a unified architecture. Additionally, the aforementioned patent does not describe machine learning-based sensor fusion, confidence weighting of sensor inputs or the generation of real-time occupancy maps that represent spatial distribution, density and movement across multiple zones.

Furthermore, the aforementioned publication fails to disclose adaptive learning mechanisms that continuously refine occupancy detection models using feedback, nor does it integrate occupancy intelligence with decentralized resource allocation or occupant comfort inference. As a result, the disclosed approach described in the aforementioned publication remains limited in accuracy, adaptability and real-time responsiveness.

Another U.S. Pat. No. 12,111,620 assigned to Tata Consultancy Services Ltd addresses energy management in buildings including multiple subsystems such as HVAC, lighting and shading. Although, the patent recognizes competition for limited resources during peak demand, it relies primarily on centralized control architectures to manage subsystem coordination.

This prior art fails to disclose a decentralized andmulti-agent AI negotiation framework in which a number of autonomous agents associated with individual subsystems dynamically negotiate resource allocation based on real-time occupancy, comfort requirements and energy constraints. The centralized approach described limits scalability, introduces computational bottlenecks and reduces system resilience.

Additionally, the U.S. Pat. No. 12,111,620 fails to disclose reinforcement learning-based optimization, negotiation logging or adaptive conflict-resolution mechanisms that improve resource allocation decisions over time. Consequently, the system lacks intelligence for autonomous, real-time optimization in complex and highly dynamic building environments.

Another Chinese Patent Application CN112764352 assigned to Nanjing Skyworth Information Technology Research Institute Co ltd., discloses an environmental control system capable of adjusting building parameters based on sensed data. While the system described in the patent introduces automation, it is primarily designed for static or pre-programmed environmental settings and does not consider occupant emotional or psychological states.

This patent fails to disclose an occupant comfort inference module that integrates thermal, acoustic, behavioral and emotional indicators to infer real-time occupant well-being. The system does not autonomously detect stress levels or emotional parameters, nor does it dynamically adapt environmental conditions based on inferred emotional states without manual intervention.

Another U.S. Pat. No. 10,845,081 assigned to Tyco Fire and Security GmbH discloses a building automation system with advanced control capabilities for HVAC and lighting. Although the system specifies automation and centralized dashboards, it still requires technical expertise to operate and does not provide an intuitive human-machine interaction layer.

Although, the U.S. Pat. No. 10,845,081 provides automation interfaces, it fails to disclose a conversational, AI-driven virtual facility manager interface that supports natural language voice and text interaction, real-time negotiation visibility and explainable decision support. The absence of conversational intelligence limits accessibility for non-technical occupants and facility managers.

Moreover, the system described above does not integrate human-in-the-loop feedback into a continuous learning framework capable of refining occupancy maps, comfort inference and decentralized resource negotiation strategies based on user interaction patterns.

Accordingly, there exists a need for an integrated, AI-driven building management system that combines multi-modal occupancy sensing, machine learning-based sensor fusion, decentralized AI agent negotiation, occupant comfort and emotional inference and intuitive conversational interfaces within a unified and scalable architecture.

The present invention fulfils this need by providing a closed-loop adaptive system that continuously senses, learns, negotiates and optimizes building resource allocation in real time, thereby overcoming the limitations of the cited prior art and enabling energy-efficient, human-centric and scalable building automation.

### SUMMARY OF THE INVENTION

Modern buildings increasingly demand intelligent control systems capable of responding dynamically to real-time occupancy, environmental conditions and occupant well-being. Conventional building management systems typically rely on static schedules, rule-based automation and centralized control architectures, which often result in inefficient energy utilization, delayed response to occupancy changes and limited consideration of occupant comfort and behaviour.

The present invention overcomes these limitations by providing a multi-modal sensor based artificial intelligence (AI) system and method for real-time occupancy detection, decentralized resource allocation and adaptive environmental control within buildings. The system enables continuous sensing, intelligent inference, autonomous negotiation and feedback-driven optimization to provide an energy-efficient and occupant-centric building environment.

The primary objective of the present invention is to disclose an integrated AI-driven building management system that combines real-time multi-modal sensing, machine learning-based sensor fusion, decentralized AI agent negotiation and automated building control within a unified and scalable architecture.

Another objective of the present invention is to provide a sensor unit including a number of multi-modal sensors configured to sense environmental conditions, occupancy presence, activity levels, acoustic patterns, thermal signatures, motion dynamics and optional emotional or behavioral indicators within one or more zones of a building. The sensor unit enables fine-grained, zone-level visibility beyond conventional room-based sensing.

A further objective of the invention is to disclose an AI controller operatively coupled to the sensor unit and configured to receive, process and analyses real-time sensor data. The AI controller functions as a central intelligence layer that orchestrates data processing, occupancy inference, comfort assessment, learning and coordination between autonomous control agents.

Another objective of the present invention is to provide a data processor within the AI controller that preprocesses a raw sensor data through filtering, normalization, noise reduction, feature extraction and temporal correlation. This preprocessing ensures reliable and consistent input for downstream machine learning and inference operations.

The present invention further aims to disclose a machine learning-based sensor fusion engine configured to fuse heterogeneous sensor data and generate real-time occupancy maps. The occupancy maps represent spatial distribution, occupancy density, movement patterns and zone utilization and may dynamically update to reflect changing building conditions.

Another objective of the invention is to provide an occupant comfort inference module that determines occupant comfort based on thermal indicators, acoustic indicators, behavioral indicators and optional emotional or stress-related parameters derived from sensor data. The comfort inference enables human-centric control decisions rather than purely energy-based optimization.

The present invention further discloses a decentralized resource allocation unit including multiple AI agents, wherein each AI agent is associated with a corresponding building subsystem or zone. The decentralized architecture eliminates reliance on a single centralized controller and improves scalability, fault tolerance and responsiveness.

An additional objective of the invention is to enable the multiple AI agents to negotiate allocation of building resources using a predefined negotiation protocol. The negotiation protocol considers factors including occupancy level, task urgency, energy cost, occupant comfort requirements and historical usage patterns.

Another objective of the present invention is to disclose the use of reinforcement learning or adaptive optimization techniques by the AI agents to improve resource allocation decisions over time. Negotiation outcomes and system performance metrics are logged to enable continuous learning and policy refinement.

The invention further aims to provide a building automation control unit operatively coupled to the AI controller and the decentralized resource allocation unit. The building automation control unit executes negotiated control actions for one or more building subsystems in real time.

A further objective of the present invention is to provide an HVAC control module within the building automation control unit for regulating heating, ventilation and air conditioning within one or more zones. HVAC operation is dynamically adjusted based on occupancy maps, comfort inference and negotiated resource allocation outcomes.

Another objective of the invention is to disclose a lighting control module configured to control illumination within one or more zones by adjusting lighting intensity, distribution, activation or color characteristics in response to occupancy presence and inferred comfort levels.

The present invention further provides a virtual AI facility manager interface operatively coupled to the AI controller and the building automation control unit. The interface enables real-time visualization of occupancy maps, subsystem status and resource allocation outcomes through dashboards and graphical representations.

An additional objective of the invention is to enable the virtual AI facility manager interface to support conversational interaction, including voice-based and text-based inputs from occupants or building managers. This allows users to monitor, negotiate, approve, override or execute control actions in a transparent manner.

Another objective of the present invention is to provide a feedback loop unit configured to collect explicit feedback from occupants and implicit feedback derived from sensor data, behavioral changes and emotional indicators following environmental adjustments.

The feedback loop unit contributes to continuous system adaptation by updating occupancy maps, comfort inference models, negotiation strategies and learning parameters within the AI controller. This closed-loop operation enables real-time refinement of control actions.

The present invention further discloses a method for real-time occupancy detection-based resource allocation and adaptive environmental control, including steps of sensing, data collection, processing, sensor fusion, comfort inference, decentralized negotiation, subsystem control and feedback-driven updating.

Another objective of the invention is to provide a method that integrates autonomous AI-driven decision-making with human-in-the-loop supervision through the virtual AI facility manager, thereby ensuring transparency, policy compliance and user trust.

Through coordinated operation of multi-modal sensing, artificial intelligence, decentralized agent negotiation, building automation and continuous feedback, the present invention enables adaptive, energy-efficient and occupant-centric building management across diverse usage scenarios.

Various objects, features and advantages of the present invention will become more apparent from the following detailed description of preferred embodiments, in which like reference numerals represent like components throughout the drawings.

Other objectives and aspects of the invention will become apparent from the detailed description taken in conjunction with the accompanying drawings, which illustrate exemplary embodiments of the invention.

The disclosed embodiments are illustrative only and modifications and variations may be made without departing from the scope of the appended claims.

The presence of broadening terms such as “one or more,” “at least,” and “including but not limited to” shall not be construed as limiting narrower implementations of the invention.

### BRIEF DESCRIPTION OF THE INVENTION

The accompanying drawings illustrate various embodiments of systems, methods and embodiments of various other aspects of the disclosure. Any person with ordinary skills in the art will appreciate that the illustrated element boundaries (e.g. boxes, groups of boxes or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being positioned upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form and some details of elements may not be shown in the interest of clarity and conciseness.

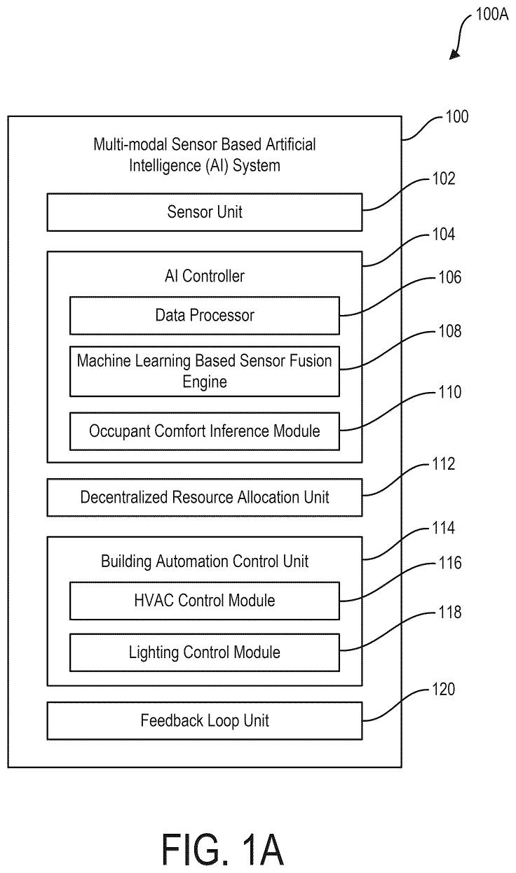

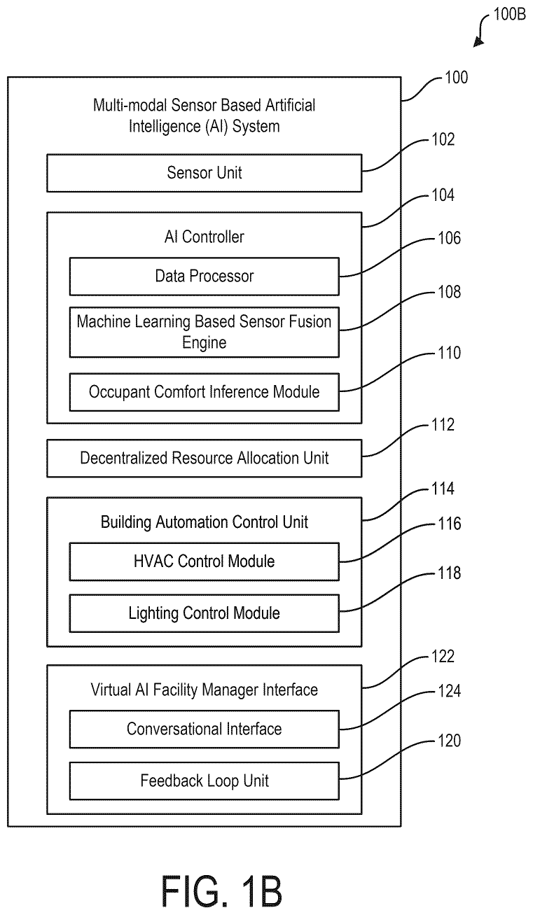

FIG. 1A illustrates a multi-modal sensor based artificial intelligence (AI) system for real-time occupancy detection-based resource allocation through multiple AI agents and providing adaptive environment to an occupant in a building in accordance with the present invention;

FIG. 1B illustrates a multi-modal sensor based artificial intelligence (AI) system for real-time occupancy detection-based resource allocation through multiple AI agents and providing adaptive environment to an occupant in the building in accordance with the present invention;

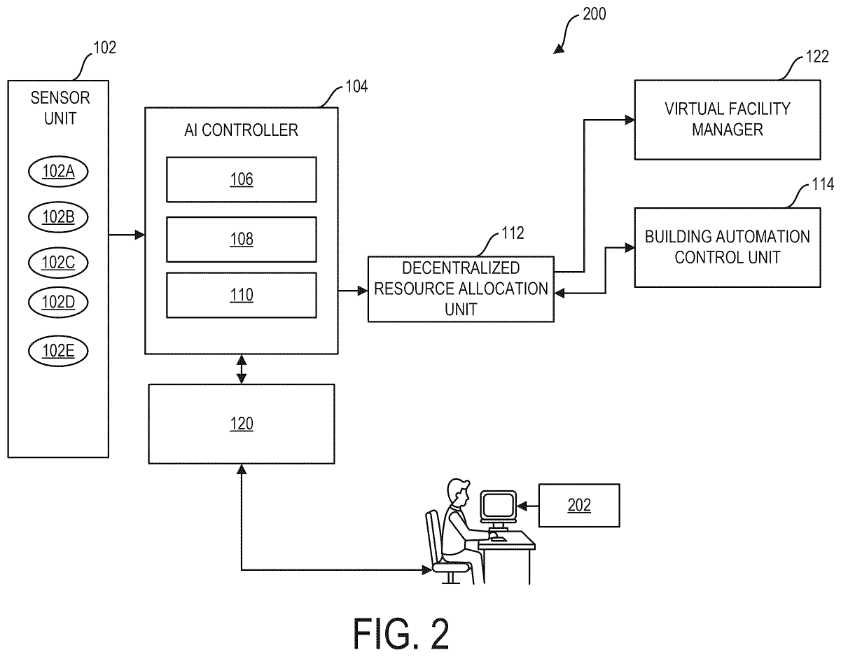

FIG. 2 illustrates a visual representation of occupancy detection and HVAC adjustment in a meeting room of the multi-modal sensor based artificial intelligence (AI) system in accordance with the present invention;

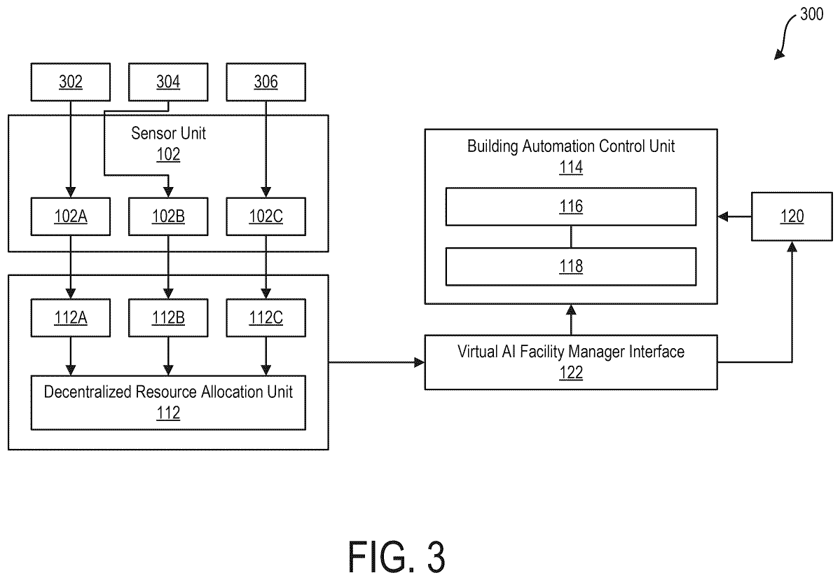

FIG. 3 illustrates a visual representation of resource allocation negotiations during peak demand of the multi-modal sensor based artificial intelligence (AI) system in accordance with the present invention;

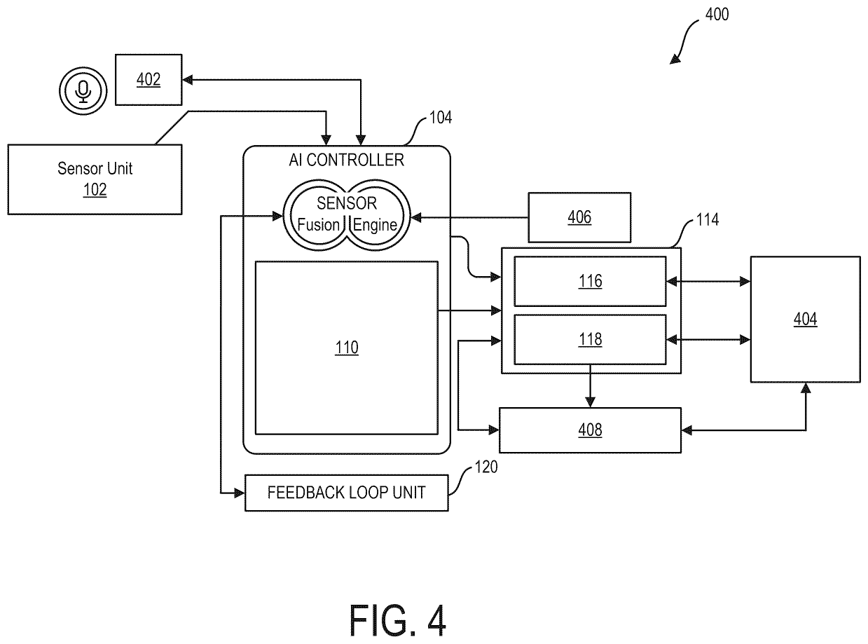

FIG. 4 illustrates a visual representation of environmental adjustments based on detected stress levels in an office environment of the multi-modal sensor based artificial intelligence (AI) system in accordance with the present invention;

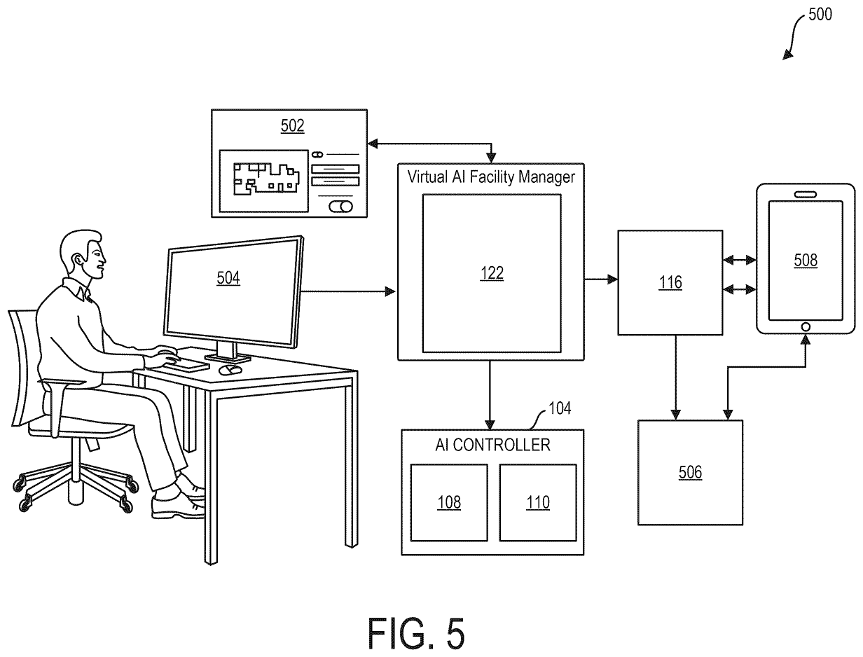

FIG. 5 illustrates a visual representation of a manager interacting with the system to adjust lighting and HVAC settings of the multi-modal sensor based artificial intelligence (AI) system in accordance with the present invention;

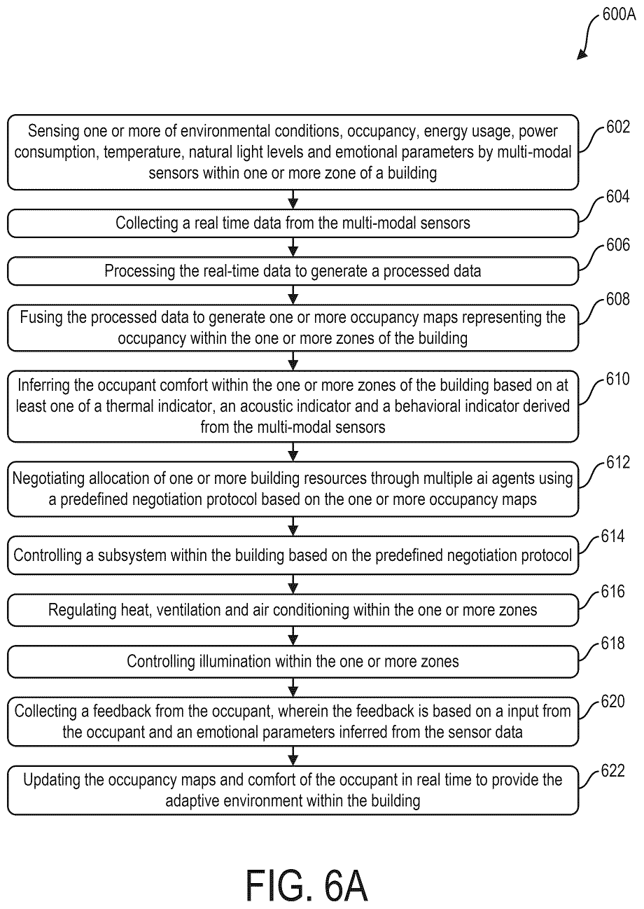

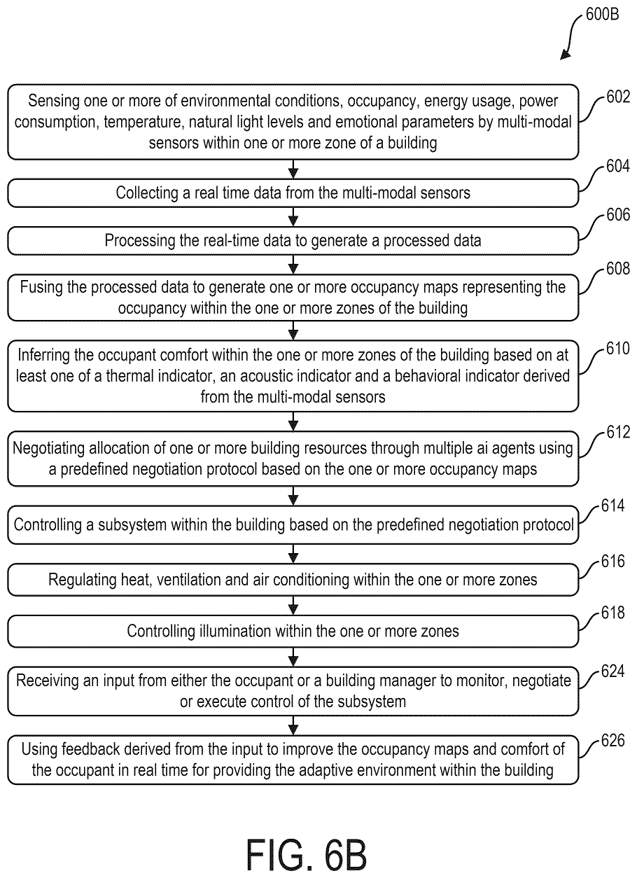

FIG. 6A illustrates a method for real-time occupancy detection-based resource allocation and providing an adaptive environment to an occupant in a building in accordance with the present invention; and

FIG. 6B illustrates a method for real-time occupancy detection-based resource allocation and adaptive environmental control in a building using a virtual AI facility manager in accordance with the present invention.

### DETAILED DESCRIPTION OF THE INVENTION

The present invention relates to a multi-modal sensor based artificial intelligence (AI) system and method for real-time occupancy detection, decentralized resource allocation and adaptive environmental control in buildings. The system integrates heterogeneous sensor data, artificial intelligence processing, decentralized AI agent negotiation and building automation control to dynamically optimize energy usage, occupant comfort and operational efficiency across one or more zones of a building. By continuously monitoring occupancy, environmental conditions and occupant behaviour, the system enables intelligent, context-aware control of building subsystems such as HVAC and lighting.

In accordance with the present invention, multi-modal sensor units deployed throughout the building collect real-time data indicative of occupancy presence, activity levels, environmental parameters and emotional or behavioral indicators of occupants. An AI controller processes and fuses the sensor data using machine-learning-based models to generate real-time occupancy maps and infer occupant comfort. Based on the generated occupancy maps and inferred comfort levels, a decentralized resource allocation framework including multiple AI agents negotiates the allocation of building resources using predefined negotiation protocols, thereby enabling adaptive, zone-specific control while avoiding centralized bottlenecks.

The system further incorporates a building automation control unit to execute negotiated control actions and a virtual AI facility manager interface to provide transparency, supervision and optional human intervention. A continuous feedback loop collects explicit user inputs, system performance metrics and inferred emotional parameters to refine models, update control strategies and improve decision accuracy over time. Accordingly, the present invention provides a scalable, human-centric and energy-efficient building management solution that seamlessly combines autonomous AI operation with explainable, human-in-the-loop control.

FIG. 1A illustrates a multi-modal sensor based artificial intelligence (AI) system (100) for real-time occupancy detection, decentralized resource allocation through multiple AI agents and providing an adaptive environment to an occupant in a building in accordance with the present invention.

The system (100) includes a sensor unit (102) deployed within one or more zones of the building. The sensor unit (102) includes a number of multi-modal sensors configured to sense environmental conditions, occupancy, movement and occupant-related parameters. The multi-modal sensors include thermal sensors, acoustic sensors and motion sensors and may further include carbon dioxide sensors, humidity sensors, light sensors, vibration sensors, energy meters and power consumption sensors. The sensor unit (102) is configured to collect real-time sensor data indicative of occupancy levels, spatial distribution of occupants, environmental conditions and occupant behavior across the one or more zones of the building.

The sensor unit (102) is operatively coupled to an AI controller (104). The AI controller (104) functions as a centralized or distributed intelligence layer responsible for processing sensor data, generating occupancy intelligence and inferring occupant comfort. Within the AI controller (104), a data processor (106) processes the real-time sensor data by performing filtering, normalization, aggregation, feature extraction and temporal alignment to generate processed data suitable for machine learning analysis.

The AI controller (104) further includes a machine learning based sensor fusion engine (108) configured to fuse the processed data from multiple heterogeneous sensors. The sensor fusion engine (108) correlates thermal, acoustic, motion and environmental signals to generate one or more real-time occupancy maps representing occupancy density, movement patterns, zone utilization and spatial distribution of occupants within the building. The sensor fusion engine (108) may assign confidence weights to sensor inputs based on sensor reliability, environmental conditions or historical performance to improve accuracy.

The AI controller (104) also includes an occupant comfort inference module (110) configured to determine occupant comfort within the one or more zones. The occupant comfort inference module (110) evaluates comfort based on thermal indicators, acoustic indicators and behavioral indicators derived from the sensor data. Behavioral indicators may include movement frequency, dwell time, interaction patterns or inferred stress or fatigue levels. In some embodiments, the occupant comfort inference module (110) further derives emotional parameters from voice tone, motion behavior or physiological proxy signals detected by the sensors.

The AI controller (104) communicates the dynamic occupancy maps and inferred comfort information to a decentralized resource allocation unit (112). The decentralized resource allocation unit (112) includes multiple autonomous AI agents, wherein each AI agent is associated with a corresponding subsystem or zone within the building. The multiple AI agents negotiate allocation of one or more building resources using a predefined negotiation protocol based on the real-time occupancy maps, occupant comfort requirements, energy cost, task urgency and occupant preferences. In some embodiments, the AI agents employ reinforcement learning to optimize resource allocation strategies over time and resolve conflicts among competing subsystems.

The negotiated resource allocation decisions are transmitted to a building automation control unit (114). The building automation control unit (114) is operatively coupled to the AI controller (104) and the decentralized resource allocation unit (112) and is configured to execute control actions based on the negotiated outcomes. The building automation control unit (114) includes an HVAC control module (116) for regulating heating, ventilation, air conditioning, airflow and humidity within the one or more zones and a lighting control module (118) for controlling illumination levels, lighting schedules and light intensity within the one or more zones.

A feedback loop unit (120) is operatively coupled to the AI controller (104). The feedback loop unit (120) is configured to collect feedback from occupants, including explicit feedback provided by the occupant and implicit feedback derived from sensor data and detected emotional parameters. The feedback loop unit (120) continuously updates the occupancy maps and occupant comfort inference in real time, thereby enabling the system (100) to adapt control actions dynamically and provide a personalized, energy-efficient and responsive building environment.

FIG. 1B illustrates an alternative embodiment of the multi-modal sensor based artificial intelligence (AI) system (100) that further incorporates a virtual AI facility manager interface (122), while retaining all functional components described in FIG. 1A.

Similar to FIG. 1A, the system (100) includes a sensor unit (102), an AI controller (104) with a data processor (106), a machine learning based sensor fusion engine (108) and an occupant comfort inference module (110), a decentralized resource allocation unit (112), a building automation control unit (114) having an HVAC control module (116) and a lighting control module (118) and a feedback loop unit (120). These components collectively perform real-time occupancy detection, comfort inference, resource negotiation and adaptive environmental control.

FIG. 1B illustrates a multi-modal sensor based artificial intelligence (AI) system (100B) for real-time occupancy detection-based resource allocation through multiple AI agents and for providing an adaptive environment to an occupant within a building, in accordance with an embodiment of the present invention. The system architecture shown in FIG. 1B represents a holistic, integrated framework combining sensing, artificial intelligence processing, decentralized negotiation, human interaction and adaptive control.

The system includes a sensor unit (102) deployed across one or more zones of the building. The sensor unit (102) includes a number of multi-modal sensors, including thermal sensors, acoustic sensors, motion sensors and optionally environmental sensors such as carbon dioxide sensors, humidity sensors, light sensors, vibration sensors and air-quality sensors. These sensors collectively capture real-time data indicative of occupancy presence, occupancy density, movement patterns, environmental conditions and human activity within the building.

The sensor unit (102) is configured to continuously transmit real-time sensor data to an AI controller (104). The AI controller (104) functions as a central intelligence layer that coordinates perception, inference, decision-making and learning across the system. The AI controller (104) is implemented using one or more processors and may be deployed centrally, at the edge or in a distributed computing architecture.

Within the AI controller (104), a data processor (106) is configured to preprocess incoming sensor data. The data processor (106) performs operations including noise filtering, normalization, time-series alignment, feature extraction, anomaly detection and sensor health assessment. This preprocessing ensures that downstream AI modules receive reliable and contextually meaningful inputs.

The processed data is forwarded to a machine learning based sensor fusion engine (108). The sensor fusion engine (108) integrates data from multiple sensor modalities to generate one or more real-time occupancy maps. These occupancy maps provide spatial representations of occupancy distribution, occupancy density, movement trajectories and zone utilization across the building, including areas where occupants may be stationary and not detectable by motion sensors alone.

The machine learning based sensor fusion engine (108) assigns confidence weights to individual sensor inputs based on sensor reliability, environmental conditions, historical performance and contextual relevance. This weighted fusion enables robust occupancy detection even under challenging conditions such as low lighting, background noise, sensor occlusion or partial sensor failure.

The AI controller (104) further includes an occupant comfort inference module (110). The occupant comfort inference module (110) analyzes fused sensor data to determine comfort levels of occupants within one or more zones. Comfort inference is performed using thermal indicators, acoustic indicators, behavioral indicators and optionally physiological proxies derived from sensor data, enabling the system to account for both physical and emotional comfort.

The occupant comfort inference module (110) is configured to detect emotional parameters such as stress, fatigue, relaxation or agitation based on indicators including voice tone patterns, speech intensity, movement behavior, occupancy duration and environmental mismatch conditions. This capability extends the system beyond conventional comfort control into emotion-aware adaptive environments, as disclosed in Invention 6.

The AI controller (104) is operatively coupled to a decentralized resource allocation unit (112) including multiple autonomous AI agents. Each AI agent is associated with a specific building subsystem and may correspond to a particular zone or function, such as HVAC, lighting, ventilation or shading systems.

The AI agents within the decentralized resource allocation unit (112) negotiate allocation of building resources using a predefined negotiation protocol. The negotiation protocol considers factors including real-time occupancy maps, inferred occupant comfort, task urgency, energy availability, energy pricing, environmental constraints and user-defined preferences, as disclosed in Invention 5.

The AI agents employ reinforcement learning and historical analysis to improve negotiation strategies over time. Each agent learns from past negotiation outcomes, system performance metrics and feedback signals to optimize future resource allocation decisions, thereby enabling adaptive, decentralized optimization without reliance on rigid centralized control logic.

Negotiated resource allocation decisions are communicated to a building automation control unit (114). The building automation control unit (114) serves as an execution layer that translates AI-generated decisions into actionable control commands for building subsystems.

The building automation control unit (114) includes an HVAC control module (116) configured to regulate heating, ventilation and air conditioning parameters such as temperature setpoints, airflow rates, ventilation schedules and humidity levels. Control actions are dynamically adjusted based on occupancy levels, comfort inference and negotiated priorities.

The building automation control unit (114) further includes a lighting control module (118) configured to control illumination parameters including brightness, color temperature, zoning and scheduling. Lighting adjustments may be personalized based on occupancy patterns, activity context, emotional comfort indicators and energy optimization objectives.

The system further includes a feedback loop unit (120) operatively coupled to the AI controller (104). The feedback loop unit (120) collects explicit feedback from occupants and building managers, as well as implicit feedback derived from sensor data, behavioral responses and system performance outcomes.

The feedback loop unit (120) continuously refines occupancy maps, comfort inference models, negotiation policies and control strategies by updating model parameters within the AI controller (104). This closed-loop learning mechanism ensures that the system adapts to changing building usage patterns, occupant preferences, seasonal variations and evolving operational constraints.

The system further includes a virtual AI facility manager interface (122) operatively coupled to the AI controller (104) and the building automation control unit (114). The virtual AI facility manager interface (122) provides a unified interaction layer for occupants and building managers to monitor system behavior and interact with building operations.

The virtual AI facility manager interface (122) includes a conversational interface (124) configured to receive voice or text inputs from occupants or facility managers. The conversational interface (124) enables natural language interaction for querying system status, requesting explanations, approving or overriding control actions and setting operational preferences.

The virtual AI facility manager interface (122) further presents real-time dashboards displaying occupancy maps, subsystem status, energy usage, negotiation outcomes and comfort metrics. The interface supports transparency, explainability and trust in AI-driven decisions while maintaining human-in-the-loop oversight.

The virtual AI facility manager interface (122) is also configured to log user interactions, AI decisions and executed control actions. These logs support diagnostics, performance analysis, compliance reporting and continuous improvement of system intelligence.

Accordingly, FIG. 1B illustrates an end-to-end intelligent building management architecture that integrates multi-modal sensing, AI-based perception, decentralized agent negotiation, emotional comfort inference, adaptive control execution, continuous learning and conversational human interaction. The system enables real-time, scalable and occupant-centric optimization of building environments while ensuring transparency, resilience and energy efficiency.

FIG. 2 illustrates a visual representation (200) of real-time occupancy detection and adaptive environmental control, including HVAC adjustment, within a meeting room, in accordance with an embodiment of the present invention.

As shown in FIG. 2, a sensor unit (102) is deployed within the meeting room and includes a number of multi-modal sensors (102A-102E). The multi-modal sensors may include thermal sensors, acoustic sensors, motion sensors, optional environmental sensors and physiological or emotional proxy sensors, configured to detect occupancy presence, activity level and environmental conditions within the meeting room.

The sensor unit (102) transmits real-time sensor data to an AI controller (104). The AI controller (104) includes a data processor (106) configured to preprocess the sensor data, a machine learning based sensor fusion engine (108) configured to fuse the processed data to generate one or more real-time occupancy maps and an occupant comfort inference module (110) configured to infer occupant comfort based on thermal, acoustic and behavioral indicators derived from the sensor data.

The AI controller (104) is operatively coupled to a decentralized resource allocation unit (112) including multiple AI agents. Each AI agent is associated with a corresponding building subsystem serving the meeting room. Based on the generated occupancy maps and inferred occupant comfort, the AI agents negotiate allocation of one or more building resources using a predefined negotiation protocol.

Negotiated resource allocation decisions are communicated to a building automation control unit (114), which executes control actions for the building subsystems. In the illustrated embodiment, the building automation control unit (114) dynamically adjusts HVAC operation via an HVAC control module (116) to regulate temperature, ventilation and airflow within the meeting room based on real-time occupancy conditions.

The system (200) further includes a virtual AI facility manager interface (122) operatively coupled to the building automation control unit (114). The virtual AI facility manager interface (122) enables monitoring, supervision and optional manual intervention by an occupant or a building manager.

A feedback loop unit (120) is operatively coupled to the AI controller (104) and receives feedback from both system-derived indicators and user interaction. As illustrated, an occupant in an office space (202) may provide explicit feedback or control inputs through the virtual AI facility manager interface (122). The feedback loop unit (120) utilizes the collected feedback to refine occupancy maps, comfort inference and control strategies in real time, thereby enabling continuous adaptation of the meeting room environment.

Accordingly, FIG. 2 demonstrates how real-time multi-modal sensing, AI-based sensor fusion, decentralized AI agent negotiation and human-in-the-loop feedback cooperate to provide an adaptive, energy-efficient and occupant-centric building environment.

FIG. 3 illustrates a visual representation (300) of decentralized resource allocation negotiations during peak demand within a building, in accordance with an embodiment of the present invention.

As illustrated, real-time data is collected from a sensor unit (102) deployed within one or more zones of the building, including Zone A (302), Zone B (304) and Zone C (306). The sensor unit (102) receives inputs from a plurality of multi-modal sensors (102A-102C), which may include thermal sensors, acoustic sensors, motion sensors and environmental sensors. The sensor data is indicative of occupancy levels, environmental conditions and energy demand during peak usage periods.

Based on the sensor data, multiple AI agents (112A, 112B, 112C) associated with respective building subsystems generate resource requests reflecting subsystem operational requirements. The AI agents (112A-112C) communicate with the decentralized resource allocation unit (112), where negotiation of building resources is performed using a predefined negotiation protocol.

The negotiation protocol considers one or more factors including task urgency, energy cost, real-time occupancy levels and occupant comfort requirements. During peak demand conditions, the AI agents negotiate to prioritize critical subsystems and dynamically adjust operational parameters to remain within energy constraints.

Negotiated resource allocation outcomes are communicated from the decentralized resource allocation unit (112) to the virtual AI facility manager interface (122). The virtual AI facility manager interface (122) provides visibility into negotiation outcomes and enables optional supervision or intervention by a building manager or facility manager (504).

The negotiation outcomes are further communicated to a building automation control unit (114), which executes control actions in accordance with the negotiated resource allocation. The building automation control unit (114) includes an HVAC control module (116) and a lighting control module (118), which dynamically adjust subsystem operation to balance energy efficiency and occupant comfort during peak demand.

A feedback loop unit (120) is operatively coupled to the building automation control unit (114) and the virtual AI facility manager interface (122). The feedback loop unit (120) collects feedback from executed control actions, system performance metrics and user interactions. The collected feedback is used to refine negotiation strategies, update learning models via a learning module (506) and improve future resource allocation decisions under similar peak demand conditions.

Accordingly, FIG. 3 clearly demonstrates cooperation of the decentralized AI agents through negotiation, feedback and adaptive control to maintain occupant comfort while optimizing resource usage during peak demand scenarios.

FIG. 4 illustrates a visual representation (400) of adaptive environmental adjustments based on detected occupant stress levels within an office environment, in accordance with an embodiment of the present invention.

As illustrated, a sensor unit (102) collects multi-modal input data indicative of occupant stress and environmental conditions. The sensor unit (102) may include, but is not limited to, acoustic sensors, microphones receiving voice or text input (402), environmental sensors and physiological proxy sensors configured to detect speech patterns, noise levels, motion irregularities or other stress-correlated signals.

The collected sensor data is transmitted to an AI controller (104). The AI controller (104) includes a machine learning based sensor fusion engine (108), which aggregates and correlates multi-modal sensor inputs to generate a contextual representation of occupant state. Based on the fused sensor data, a stress level detector (406) determines one or more stress indicators associated with an occupant or group of occupants within the office environment.

Upon detecting elevated stress levels, the AI controller (104) generates adaptive control instructions using the occupant comfort inference module (110). The occupant comfort inference module (110) may employ machine learning models, rule-based logic or reinforcement learning techniques to determine optimal environmental adjustments that are likely to reduce occupant stress while maintaining energy efficiency.

The control instructions are communicated to environmental control subsystems via the building automation control unit (114), including an HVAC control module (116) and a lighting control module (118). The HVAC control module (116) adjusts parameters such as temperature, airflow or humidity, while the lighting control module (118) modifies lighting intensity, color temperature or distribution patterns to improve occupant comfort.

The environmental control subsystems may further interact with an occupant's wellbeing monitor (404) to synchronize environmental adjustments with occupant wellness metrics, preferences or organizational policies.

An adaptive environment (408) reflects the resulting environmental conditions produced by the executed control actions. Feedback associated with the adaptive environment (408) is collected and communicated to a feedback loop unit (120), which updates learning parameters, decision logic and inference models within the AI controller (104) to continuously improve stress detection and mitigation accuracy.

Accordingly, FIG. 4 demonstrates a closed-loop, human-centric building control architecture in which occupant stress levels are autonomously detected and mitigated through adaptive environmental adjustments, thereby enhancing occupant well-being while maintaining operational efficiency.

FIG. 5 illustrates a visual representation (500) of a virtual AI facility manager interface enabling human-AI collaboration, learning and decision transparency for adaptive building management, in accordance with an embodiment of the present invention.

As illustrated in FIG. 5, the system includes a virtual AI facility manager interface (122) presented through a virtual dashboard (502). The virtual dashboard (502) provides a centralized, graphical and interactive view of real-time building operations, occupancy conditions, resource allocation decisions and adaptive environmental control actions generated by the system.

The virtual AI facility manager interface (122) is communicatively coupled to the AI controller (104) and the building automation control unit (114). Through this interface, a building manager or facility manager (504) is enabled to monitor system status, review automated decisions and optionally intervene in control execution when required by operational policies or exceptional conditions.

The virtual dashboard (502) displays real-time data derived from the sensor unit (102), including occupancy distribution, environmental parameters, energy usage and subsystem status across one or more building zones. The displayed information may be aggregated, filtered or visualized in multiple formats to enhance situational awareness for the building manager (504).

The virtual AI facility manager interface (122) further includes a conversational interface (124) configured to receive voice or text input (402) from the building manager (504). The conversational interface (124) enables natural-language interaction with the AI controller (104), allowing the building manager (504) to query system status, request explanations of decisions, modify preferences or initiate manual overrides.

The conversational interface (124) communicates received inputs to the AI controller (104), where the inputs are interpreted and contextualized using natural language processing and decision-support logic. Based on the interpreted input, the AI controller (104) may adjust control parameters, initiate new negotiation cycles within the decentralized resource allocation unit (112) or update operational objectives.

The system further includes a learning module (506) operatively coupled to the AI controller (104). The learning module (506) analyzes historical data, system performance metrics, feedback signals and interaction logs to continuously improve prediction accuracy, negotiation strategies and occupant comfort inference over time.

Decisions generated by the AI controller (104), including negotiated resource allocation outcomes and executed control actions, are recorded within a decision log (508). The decision log (508) maintains a time-stamped record of AI-generated decisions, rationale indicators, system constraints and resulting outcomes, thereby providing traceability, auditability and regulatory compliance support.

The decision log (508) is accessible through the virtual dashboard (502), enabling the building manager (504) to review prior actions, analyze system behavior and validate AI decision processes. This transparency enhances trust in autonomous operation and facilitates informed human oversight.

The virtual AI facility manager interface (122) is further operatively coupled to a feedback loop unit (120). Feedback may be derived from system performance metrics, updated sensor readings, occupant responses or explicit inputs provided by the building manager (504) through the conversational interface (124).

The feedback loop unit (120) communicates collected feedback to the AI controller (104) and the learning module (506). The feedback is used to refine internal models, update comfort thresholds, adjust negotiation priorities and improve future decision-making accuracy under similar operating conditions.

Accordingly, FIG. 5 demonstrates an integrated human-in-the-loop control architecture in which a virtual AI facility manager interface (122), conversational interaction, continuous learning and decision transparency cooperate to enable adaptive, explainable and intelligent building management while maintaining operational efficiency and occupant comfort.

FIG. 6A illustrates a method (600) for real-time occupancy detection-based resource allocation and for providing an adaptive environment to an occupant within a building, in accordance with an embodiment of the present invention.

At step 602, the method includes sensing one or more parameters within one or more zones of the building using a number of multi-modal sensors. The sensed parameters may include occupancy presence, occupancy density, movement patterns, environmental parameters such as temperature, humidity, air quality, acoustic levels, lighting conditions, energy usage and emotional or behavioral indicators associated with one or more occupants.

At step 604, the method includes collecting real-time data from the multi-modal sensors deployed within the one or more zones of the building. The collected data may be continuously streamed or periodically sampled and transmitted to an AI-based processing system. In certain embodiments, the real-time data is time-synchronized across heterogeneous sensor types, tagged with zone identifiers and associated with metadata such as sensor confidence scores, sensor health status and temporal context. This enables reliable correlation of data originating from different sensing modalities and physical locations.

At step 606, the collected real-time data is processed to generate processed data suitable for inference and decision-making. Processing may include noise suppression, sensor drift correction, normalization across sensor units, temporal smoothing and feature extraction. In some embodiments, historical data windows are used to identify trends, recurring patterns or anomalies, while edge or cloud-based processing architectures may be employed to balance latency, scalability and computational efficiency.

At step 608, the processed data is fused using a machine-learning-based sensor fusion engine to generate one or more occupancy maps. The occupancy maps may represent spatial distribution, density, dwell time and movement trajectories of occupants across zones. The fusion process may leverage probabilistic models, deep learning or rule-based correlation techniques to resolve ambiguities, compensate for missing data and dynamically update occupancy representations in near real time.

At step 610, the method includes inferring occupant comfort within the one or more zones based on thermal indicators, acoustic indicators and behavioral indicators derived from the fused data. The comfort inference may further incorporate inferred emotional or stress-related parameters, such as agitation, fatigue or cognitive load, derived indirectly from speech characteristics, movement irregularities or environmental interactions. In some embodiments, comfort inference is personalized using learned occupant profiles and historical feedback.

At step 612, the method includes negotiating allocation of one or more building resources through multiple artificial intelligence agents using a predefined negotiation protocol. Each AI agent corresponds to a specific building subsystem and evaluates resource requirements based on occupancy maps, inferred comfort, predicted demand and operational constraints. The negotiation protocol may consider competing priorities, energy pricing signals, sustainability targets and comfort impact scores to reach a consensus allocation decision.

At step 614, the method includes controlling one or more building subsystems based on outcomes of the negotiation protocol. Control signals are generated and transmitted to building automation components in a coordinated manner to ensure that negotiated decisions are executed consistently across zones. In some embodiments, control actions are staged or ramped gradually to avoid abrupt environmental changes.

At step 616, the method includes regulating heating, ventilation and air conditioning (HVAC) within the one or more zones of the building. HVAC regulation may include adjusting temperature setpoints, airflow distribution, ventilation rates, humidity control or operational schedules. The regulation is dynamically aligned with real-time occupancy density, comfort inference and negotiated energy budgets to optimize both occupant well-being and energy efficiency.

At step 618, the method includes controlling illumination within the one or more zones by adjusting lighting intensity, spatial distribution, color temperature or lighting profiles. Lighting control may account for occupancy presence, inferred comfort or stress levels, circadian rhythm considerations, availability of natural daylight and energy optimization goals.

At step 620, the method includes collecting feedback from the occupant based on explicit user input and/or implicit behavioral or emotional indicators inferred from updated sensor data following environmental adjustments.

At step 622, the method includes updating the occupancy maps, comfort inference models, negotiation parameters and control strategies in real time based on the collected feedback, thereby continuously improving system performance and adaptability.

FIG. 6B illustrates a method (600B) for real-time occupancy detection-based resource allocation and adaptive environmental control in a building using a virtual AI facility manager, in accordance with an embodiment of the present invention.

At step 602, the method includes sensing one or more parameters within one or more zones of the building using multi-modal sensors, including environmental, occupancy, energy and behavioral sensing devices.

At step 604, the method includes collecting real-time data from the multi-modal sensors deployed within the one or more zones. The data may be aggregated across zones and contextualized with zone-level metadata, system status indicators and historical references to enable centralized visibility and supervisory analysis by the virtual AI facility manager.

At step 606, the collected data is processed to generate processed data through filtering, normalization, feature extraction and temporal analysis. In certain embodiments, processing includes evaluating confidence levels of inferred states and identifying uncertainty conditions that may require human oversight or confirmation.

At step 608, the processed data is fused to generate one or more occupancy maps that represent spatial and temporal occupancy characteristics of the building. These occupancy maps may be visualized, summarized or abstracted for presentation through the virtual AI facility manager interface.

At step 610, the method includes inferring occupant comfort based on thermal, acoustic and behavioral indicators derived from the fused sensor data. The inferred comfort state may be translated into human-readable insights or alerts for review by a building manager through the virtual interface.

At step 612, the method includes negotiating allocation of one or more building resources through multiple AI agents based on the occupancy maps and inferred comfort levels. The negotiation process may generate explainable decision metrics, trade-off summaries or recommended actions suitable for supervisory review.

At step 614, the method includes controlling one or more building subsystems in accordance with the negotiated resource allocation, either autonomously or subject to approval via the virtual AI facility manager interface.

At step 616, the method includes regulating HVAC operation within the one or more zones by dynamically adjusting operational parameters in response to negotiated decisions and comfort requirements.

At step 618, the method includes controlling illumination within the one or more zones by modifying lighting parameters based on occupancy, comfort inference and supervisory preferences defined through the virtual interface.

At step 624, the method includes receiving an input from at least one of an occupant or a building manager through the virtual AI facility manager interface to monitor system status, approve recommendations, override decisions or manually initiate control actions.

At step 626, the method includes using feedback derived from the received input to refine occupancy maps, comfort inference models, negotiation strategies and control policies in real time, enabling continuous learning and transparent human-in-the-loop adaptation.

Accordingly, FIG. 6B illustrates a hybrid AI-human control method that integrates autonomous decision-making with explainable, supervised building management through a virtual AI facility manager.

The present invention provides a comprehensive and intelligent building management framework that unifies multi-modal sensing, artificial intelligence, decentralized decision-making and automated control into a single, cohesive architecture. By continuously learning from real-time and historical data, the system dynamically adapts to changing occupancy patterns, environmental conditions and occupant comfort requirements, thereby overcoming the rigidity and inefficiencies of conventional building management systems.

The disclosed system and methods enable predictive, occupant-centric and energy-efficient operation across diverse building environments, including commercial offices, residential complexes, healthcare facilities and educational institutions. The integration of decentralized AI agents, sensor fusion, comfort inference and a virtual AI facility manager ensures scalability, resilience, transparency and ease of use while reducing operational costs and improving overall building performance.

Although specific embodiments of the invention have been described in detail, it will be apparent to those skilled in the art that various modifications, variations and alternative implementations may be made without departing from the spirit and scope of the invention. Accordingly, the scope of the present invention should be determined by the appended claims and their equivalents, rather than by the foregoing description alone.

1. A multi-modal sensor based artificial intelligence (AI) system for real-time occupancy detection-based resource allocation through multiple AI agents and providing adaptive environment to an occupant in a building, wherein the multi-modal sensor based artificial intelligence (AI) system comprising:
a sensor unit with a plurality of multi-modal sensors within the building, wherein the plurality of multi-modal sensors include thermal sensors, acoustic sensors and motion sensors, further wherein the sensor unit is configured to collect sensor data in real time indicative of the occupancy within one or more zones of the building;
an AI controller operatively coupled to the sensor unit and configured to receive the sensor data, wherein the AI controller includes:
a data processor configured to process the sensor data to generate a processed data;
a machine learning based sensor fusion engine configured to fuse the processed data to generate one or more occupancy maps in real time representing the occupancy within the one or more zones within the building; and
an occupant comfort inference module configured to determine comfort of the occupant within the one or more zones based on at least one of the indicators including thermal indicator, acoustic indicator and behavioural indicator derived from the sensor data;
a decentralized resource allocation unit with the multiple AI agents, wherein each AI agent is associated with a subsystem in the one or more zones within the building, further wherein the multiple AI agents negotiate allocation of the one or more resources using a predefined negotiation protocol based on the one or more dynamic occupancy maps in real-time;
a building automation control unit operatively coupled to the AI controller and the decentralized resource allocation unit, wherein the building automation control unit is configured to control the subsystem based on a predefined negotiation protocol, the building automation control unit including:
an HVAC control module for regulating heat, ventilation and air conditioning within the one or more zones; and
a lighting control module for controlling illumination within the one or more zones; and
a feedback loop unit operatively coupled to the AI controller, wherein the feedback loop unit is configured to collect a feedback of the occupant including an input from the occupant and one or more emotional parameters detected from the sensor data within the one or more zones, further wherein the feedback improves the one or more occupancy maps and comfort-of the occupant in real time for providing the adaptive environment to the occupant in the building.

2. The system in accordance with claim 1, wherein the plurality of multi-modal sensors include thermal sensors for detecting the occupant based on thermal signatures.

3. The system in accordance with claim 1, wherein the plurality of multi-modal sensors include acoustic sensors for capturing sound patterns indicative of activities of the occupant.

4. The system in accordance with claim 1, wherein the plurality of multi-modal sensors include motion sensors for detecting change in the occupancy.

5. The system in accordance with claim 1, wherein the plurality of multi-modal sensors further include carbon dioxide sensors, humidity sensors, light sensors or vibration sensors installed within the one or more zones.

6. The system in accordance with claim 1, wherein the AI controller includes a machine learning-based sensor fusion engine configured to fuse the data from the plurality of multi-modal sensors and assign confidence weights to the sensor data based on reliability of the multi-modal sensors or environmental conditions.

7. The system in accordance with claim 1, wherein the one or more occupancy maps include spatial representations of the occupancy distribution including at least one of occupancy density, movement patterns or utilization of the one or more zones.

8. The system in accordance with claim 1, wherein the AI controller further includes a learning module based on one or more machine learning models, further wherein the one or more machine learning models include an adaptive model parameter, further wherein the adaptive model parameter gets updated based on the historical data and the feedback.

9. The system in accordance with claim 1, wherein the subsystem includes at least one of a HVAC subsystem, a lighting subsystem or a ventilation subsystem.

10. The system in accordance with claim 1, wherein the predefined negotiation protocol is based on at least one of level of the occupancy, task urgency, energy cost or preference of the occupant.

11. The system in accordance with claim 1, wherein the occupant comfort inference module determines comfort of the occupant based on combination of thermal indicators, acoustic indicators and behavioural indicators.

12. The system in accordance with claim 1, wherein the system further includes a virtual AI facility manager interface operatively coupled to the AI controller and the building automation control unit, further wherein the virtual AI facility manager interface is configured to present real-time visual dashboards displaying the occupancy maps, status of the subsystem and information based on the one or more resources.

13. The system in accordance with claim 1, wherein the predefined negotiation protocol includes a conflict resolution mechanism to ensure equitable distribution the one or more resources within the subsystem.

14. The system in accordance with claim 1, wherein the system further includes an anomaly detection mechanism to identify unusual activity or malfunction in the multi-model sensors.

15. A multi-modal sensor based artificial intelligence (AI) system for real-time occupancy detection based resource allocation through multiple AI agents and providing adaptive environment to an occupant in a building, wherein the multi-modal sensor based artificial intelligence (AI) system comprising:
a sensor unit with a plurality of multi-modal sensors within the building, wherein the plurality of multi-modal sensors including thermal sensors, acoustic sensors and motion sensors, further wherein the sensor unit is configured to collect sensor data in real time indicative of the occupancy within one or more zones of the building;
an AI controller operatively coupled to the sensor unit and configured to receive the sensor data, wherein the AI controller includes:
a data processor configured to process the sensor data to generate a processed data;
a machine learning based sensor fusion engine configured to fuse the processed data to generate one or more occupancy maps in real time representing the occupancy within the one or more zones within the building; and
an occupant comfort inference module configured to determine comfort of the occupant within the one or more zones based on at least one of the indicators including thermal indicator, acoustic indicator and behavioural indicator derived from the sensor data;
a decentralized resource allocation unit with the multiple AI agents, wherein each AI agent is associated with a subsystem in the one or more zones within the building, further wherein the multiple AI agents negotiate allocation of the one or more resources using a predefined negotiation protocol based on the one or more dynamic occupancy maps in real-time;
a building automation control unit operatively coupled to the AI controller and the decentralized resource allocation unit, wherein the building automation control unit is configured to control the subsystem based on a predefined negotiation protocol, the building automation control unit including:
an HVAC control module for regulating heat, ventilation and air conditioning within the one or more zones; and
a lighting control module for controlling illumination within the one or more zones; and
a virtual AI facility manager interface operatively coupled to the AI controller and the building automation control unit, wherein the virtual AI facility manager interface is configured to receive an input from either the occupant or a building manager to monitor, negotiate and execute control of the subsystem, further wherein the virtual AI facility manager interface includes:
a conversational Interface for establishing interaction of the occupant based on the input including voice commands, text input, kiosks or smart speakers; and
a feedback loop unit configured to collect a feedback of the occupant based on the input, wherein the feedback improves the one or more occupancy maps and comfort of the occupant in real time for providing the adaptive environment to the occupant in the building.

16. The system in accordance with claim 15, wherein the virtual AI facility manager interface receives the input from the occupant for monitoring, approving or overriding operations of the subsystem, further wherein the operations include activation or deactivation of a device or environmental regulations within the one or more zones.

17. The system in accordance with claim 15, wherein the data from the occupant is anonymized to preserve privacy of the occupant.

18. The system in accordance with claim 15, wherein AI controller includes a personalization module for adapting recommendations and settings of the virtual AI facility manager interface based on preferences of the occupant.

19. A method for real-time occupancy detection-based resource allocation and providing an adaptive environment to an occupant in a building, the method comprising:
sensing one or more of environmental conditions, occupancy, energy usage, power consumption, temperature, natural light levels and emotional parameters by multi-modal sensors within one or more zone of a building;
collecting a real time data from the multi-modal sensors;
processing the real-time data to generate a processed data;
fusing the processed data to generate one or more occupancy maps representing the occupancy within the one or more zones of the building;
inferring the occupant comfort within the one or more zones of the building based on at least one of a thermal indicator, an acoustic indicator and a behavioural indicator derived from the multi-modal sensors;
negotiating allocation of one or more building resources through multiple AI agents using a predefined negotiation protocol based on the one or more occupancy maps;
controlling a subsystem within the building based on the predefined negotiation protocol;
regulating heat, ventilation and air conditioning within the one or more zones;
controlling illumination within the one or more zones;
collecting a feedback from the occupant, wherein the feedback is based on an input from the occupant and an emotional parameters inferred from the sensor data; and
updating the occupancy maps and comfort of the occupant in real time to provide the adaptive environment within the building.

20. A method for real-time occupancy detection based resource allocation and adaptive environmental control in a building using a virtual AI facility manager, the method comprising:
sensing one or more of environmental conditions, occupancy, energy usage, power consumption, temperature, natural light levels and emotional parameters by a multi-modal sensors within the building;
collecting a real time data from the multi-modal sensors;
processing the real-time data to generate a processed data;
fusing the processed data to generate one or more real-time occupancy maps representing occupancy within the one or more zones of the building;
determining occupant comfort within the one or more zones based on thermal, acoustic and behavioural indicators derived from the sensor data;
negotiating allocation of building resources through multiple AI agents based on the one or more real-time occupancy maps;
controlling a subsystem within the building based on predefined negotiation protocol;
regulating heat, ventilation and air conditioning within the one or more zones;
controlling illumination within the one or more zones;
receiving an input from either the occupant or a building manager to monitor, negotiate or execute control of the subsystem; and
using feedback derived from the input to improve the occupancy maps and comfort of the occupant in real time for providing the adaptive environment within the building.
